(19) United States
(12) Patent Application Publication
(10) Pub. No.: US 2007/0175975 A1
(43) Pub. Date: Aug. 2, 2007

(54) Method and apparatus for providing DVD content with rendering device in UPnP network

(75) Inventors: Bong-yeon Kim, Seongnam-si (KR); Eun-jung Kang, Suwon-si (KR); Hyo-dae Kim, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/654,618

(22) Filed: Jan. 18, 2007

(30) Foreign Application Priority Data
Jan. 27, 2006 (KR) 10-2006-0009075
Jan. 27, 2006 (KR) 10-2006-0009076

(51) Int. Cl. G06F 17/00; G06F 15/167

(52) U.S. Cl. 235/375; 709/213

(57) ABSTRACT

An apparatus and method for transmitting digital versatile disc (DVD) content to a media renderer according to a menu set by a user via a network are provided. In the apparatus and method, a media server generates two or more types of menu setting information from combinations of options available from a menu for the DVD content, generates item information for the DVD content for each piece of the menu setting information, and transmits the item information to a control point. Accordingly, a user can use various menu information items for a DVD title which is the same as can be obtained in a local DVD system while evaluating DVD content under remote control via a network.

### CROSS-REFERENCE TO RELATED PATENT APPLICATIONS

This application claims priority of Korean Patent Application Nos. 10-2006-0009075 and 10-2006-0009076, filed on Jan. 27, 2006, in the Korean Intellectual Property Office, the disclosures of which are incorporated herein in their entirety by reference.

### BACKGROUND OF THE INVENTION

1. Field of the Invention

Apparatuses and methods consistent with the present invention relate to a home network, and more particularly, to a method of using digital versatile disc (DVD) content in a Universal Plug and Play (UPnP) network.

2. Description of the Related Art

Universal Plug and Play (UPnP) is a technology for establishing communications among a plurality of devices connected via a network that does not require a complicated setup process, whereby it automatically allows a device to detect a service provided by another device. If a user simply connects a device to a UPnP network, devices connected to the UPnP network automatically detect the connected device, and the user can easily use a desired service provided by one of the devices that has been previously connected to the UPnP network.

FIG. 1 is a diagram illustrating a conventional method of using content in a UPnP network. Referring to FIG. 1, a control point, that is, a device providing a user interface, inquires of a media server, which is a source device providing content, about content information. The media server provides a Content Directory Service (CDS) that defines actions allowing the control point to search for and manage content stored in the media server. A Browse call message is a representative example of the actions. The control point transmits a Browse call message to obtain information about content that the media server can provide, in the form of eXtensible Markup Language (XML).

Upon receiving the information about the content, the control point transmits a Play call message which is an action defined in an AVTransport Service (AVTS) of the media renderer in order to request reproduction of a piece of the content that the media server can provide. In this case, the Uniform Resource Identifiers (URI) of the requested piece of content are transmitted to the media renderer, and thus, the media renderer requests the media server to transmit the requested piece of content by sending an HTTP-GET request to the media server, based on the URI. The media server receiving the HTTP-GET request transmits a stream of the requested piece of content to the media renderer so that the media renderer can reproduce the requested piece of content. The media renderer provides a Rendering Control Service (RCS) that defines actions for controlling the state of the media renderer, such as the volume, contrast, and brightness thereof.

Here, as illustrated in FIG. 2, an XML document that the control point receives by transmitting the Browse call message contains a title, resource URI, and protocol information.

When UPnP is applied to a digital versatile disc (DVD) system, the media server can transmit DVD content to the media renderer via a network. However, with a conventional method of displaying content information using a UPnP CDS, it is impossible to display DVD menu information (audio, language, subtitles, etc.) that the DVD system provides.

That is, as illustrated in FIG. 2, a conventional CDS of the media server provides the URI of DVD content, and thus, the media renderer must request transmission of the DVD content corresponding to the URI. Thus, while reproducing content of a DVD system via a network, a user cannot use various additional functions of a DVD, e.g., audio selection, subtitle selection, and language selection.

### SUMMARY OF THE INVENTION

The exemplary embodiments of the present invention provide an apparatus and method for transmitting menu information of digital versatile disc (DVD) content to a control point, and the DVD content to a media renderer according to a menu set by a user via a Universal Plug and Play (UPnP) network.

According to an aspect of the present invention, there is provided a method of allowing a media server to provide digital versatile disc (DVD) content in a universal play an plug (UPnP) network, the method comprising: (a) generating at least two types of menu setting information from combinations of all options available from a menu for the DVD content; (b) generating item information for the DVD content for each piece of the menu setting information, and transmitting the generated item information to a control point; and (c) transmitting the DVD content to a media renderer designated by the control point, to which menu setting information corresponding to an item requested by the control point is applied.

Generating item information and transmitting the generated item information may comprise transmitting the item information in response to a CDS browse call message from the control point.

Each piece of the menu setting information may be inserted into a tag representing a title of the DVD content in the corresponding item information.

Transmitting the DVD content may comprise: (c1) receiving a request for content corresponding to an item corresponding to a piece of the generated item information from the media renderer; (c2) generating stream data of the DVD content by reflecting menu setting information corresponding to the requested item; and (c3) transmitting the stream data to the media renderer.

The menu setting information may comprise information for selection of at least one of a language, an audio mode, and subtitles.

According to another aspect of the present invention, there is provided a computer readable medium having recorded thereon a computer program for executing the method of allowing a media server to provide DVD content.

According to another aspect of the present invention, there is provided a media server apparatus for providing digital versatile disc (DVD) content in a universal plug and play (UPnP) network, the media server apparatus comprising: a menu setting information generating unit generating two or more types of menu setting information from combinations of options available from a menu for the DVD content; an item information providing unit generating item information for the DVD content for each piece of the generated menu setting information, and transmitting the generated item information to a control point; and a content transmission unit transmitting the DVD content to a media renderer, which is designed by the control point, to which menu setting information corresponding to an item requested by the control point is applied.

### BRIEF DESCRIPTION OF THE DRAWINGS

The above and other aspects and features of the present invention will become more apparent by describing in detail exemplary embodiments thereof with reference to the attached drawings in which:

FIG. 1 is a diagram illustrating a conventional method of using content in a universal plug and play (UPnP) network;

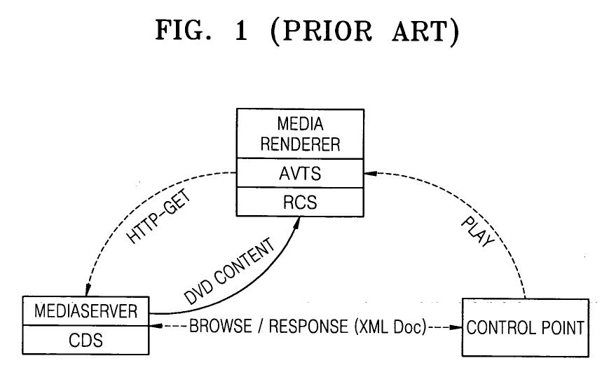

FIG. 2 illustrates content information defined in a conventional Content Directory Service (CDS) of a media server;

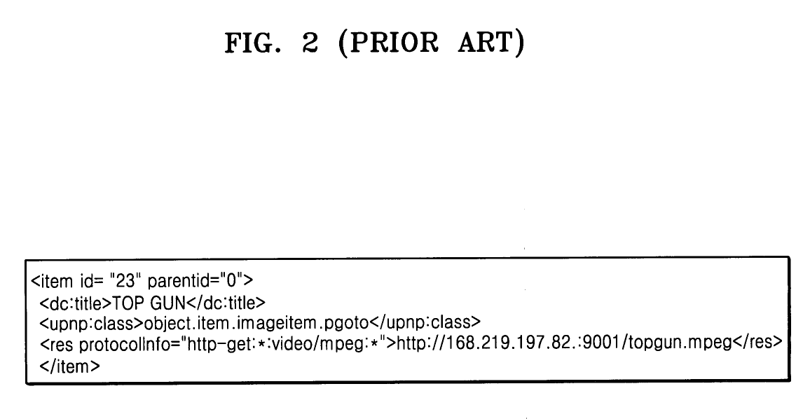

FIG. 3 is a flowchart illustrating a process of allowing a media server to provide digital versatile disc (DVD) content to a media renderer according to an exemplary embodiment of the present invention;

FIG. 4 illustrates the structure of a message that a media server provides in response to a call for Browse according to an exemplary embodiment of the present invention;

FIGS. 5A and 5B illustrate a method of constructing menu setting information of DVD content according to an exemplary embodiment of the present invention; and

FIG. 6 is a block diagram of a media server according to an exemplary embodiment of the present invention.

### DETAILED DESCRIPTION OF THE EXEMPLARY EMBODIMENTS

Hereinafter, exemplary embodiments of the present invention will be described in detail with reference to the accompanying drawings.

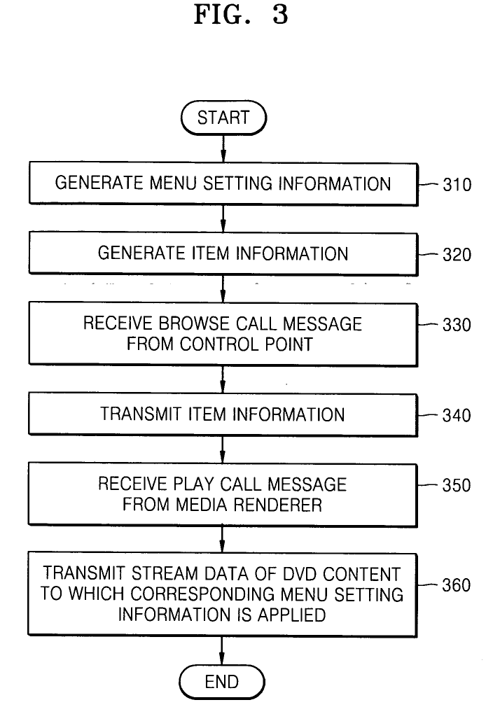

FIG. 3 is a flowchart illustrating a process of allowing a media server to provide digital versatile disc (DVD) content to a media renderer according to an exemplary embodiment of the present invention. Referring to FIG. 3, the media server retaining the DVD content extracts menu information from a DVD, and generates at least two types of menu setting information from combinations of options that a user can select from a menu (operation 310). Then, the media server generates item information for each piece of the menu setting information (operation 320). Here, the item information indicates units of information having different item identifiers (IDs) in a UPnP Content Directory Service (CDS). For example, when Korean or English may be selected as both a language and subtitles from a DVD title menu, there are four combinations of options. Thus, four pieces of item information will be obtained.

Thereafter, when the media server receives from a control point a Browse call message inquiring about information on content that the media server can provide (operation 330), the media server transmits a response message containing the item information generated in operation 320 to the control point in response to the Browse call message (operation 340).

If the control point receiving the response message selects a piece of the item information and requests a specific media renderer to reproduce the selected content, the media renderer transmits a Play call message requesting reproduction of the selected content to the media server (operation 350). Then, the media server parses the Play call message in order to analyze menu setting information corresponding to the parsing result, generates stream data of the DVD content by reflecting the corresponding menu setting information, and transmits the stream data of the DVD content to the media renderer (operation 360).

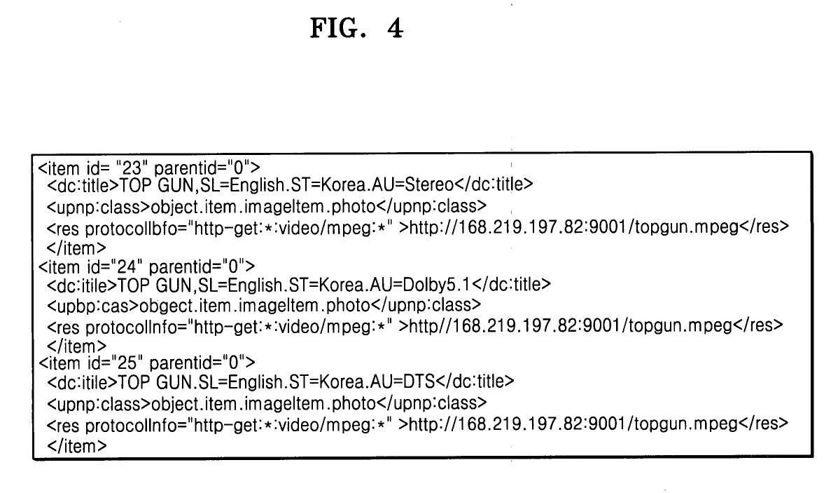

FIG. 4 illustrates the construction of a message that a media server transmits in response to a Browse call message according to an exemplary embodiment of the present invention. Referring to FIG. 4, three types of menu setting information are set for the same DVD title, and item information for each piece of the menu setting information is generated. That is, if the item ID of an item is 23, a language (SL) is set to English, subtitles (ST) are set to Korean, and audio (AU) is set to a stereo mode. If the item ID of an item is 24, a language SL is set to English, subtitles ST are set to Korean, and audio AU is set to a Dolby 5.1 mode. If the item ID of an item is 25, a language SL is set to English, subtitles ST are set to Korean, and audio AU is set to a Digital Theater System (DTS) mode.

When a control point sends a Browse call message defined in a CDS of the media server, the media server transmits a Browse response message in the format illustrated in FIG. 4 to the control point in response to the Browse call message. Upon receiving the response message, the control point selects one of the items recited in the response message and requests a media renderer to reproduce the selected item. Therefore, a user can evaluate a DVD title by reflecting menu setting information set by him or herself.

The menu setting information may be obtained by defining a new tag and inserting the new tag into the Browse response message, but subtitle setting information is preferably inserted into a <title> tag so that a user can recognize the subtitle setting information via a user interface of the control point without adding a function for interpreting a new tag by the control point.

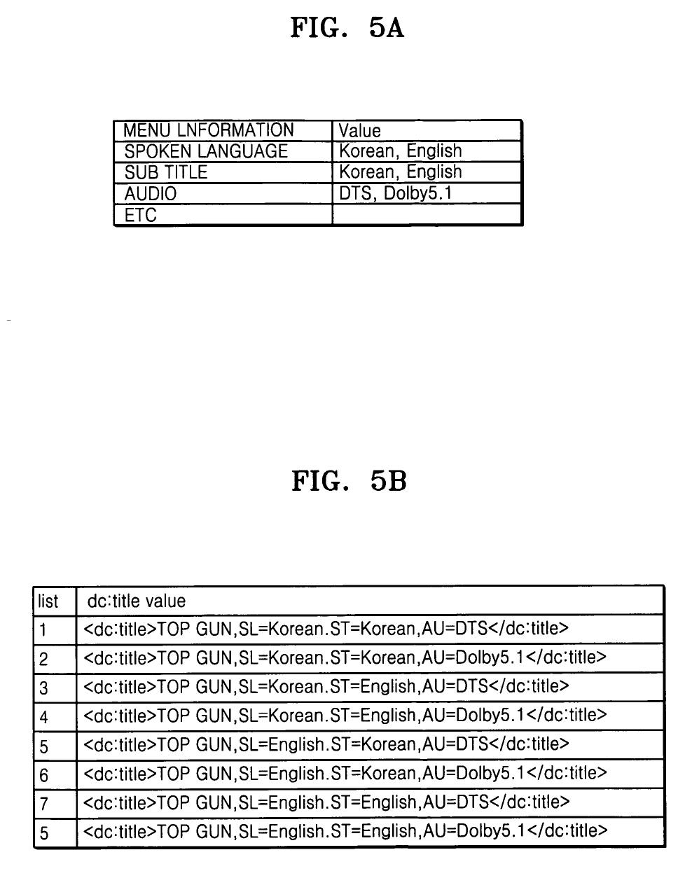

FIGS. 5A and 5B illustrate a method of constructing menu setting information of DVD content according to an exemplary embodiment of the present invention. In detail, FIG. 5A illustrates a menu from which options related to a DVD may be selected according to an exemplary embodiment of the present invention. That is, when a local DVD system reproduces a DVD title, Korean or English may be selected for both a language and subtitle, and audio may be set to one of the DTS mode and the Dolby 5.1 mode.

FIG. 5B illustrates a plurality of pieces of menu setting information that can be generated from combinations of options available, when a menu for a DVD title is the same as that illustrated in FIG. 5A. Specifically, since each of the three menu information items has two options, eight pieces of menu setting information are generated from combinations of all the options as illustrated in FIG. 5B. As described above, the generated menu setting information is inserted into a plurality of pieces of item information each having a different item ID.

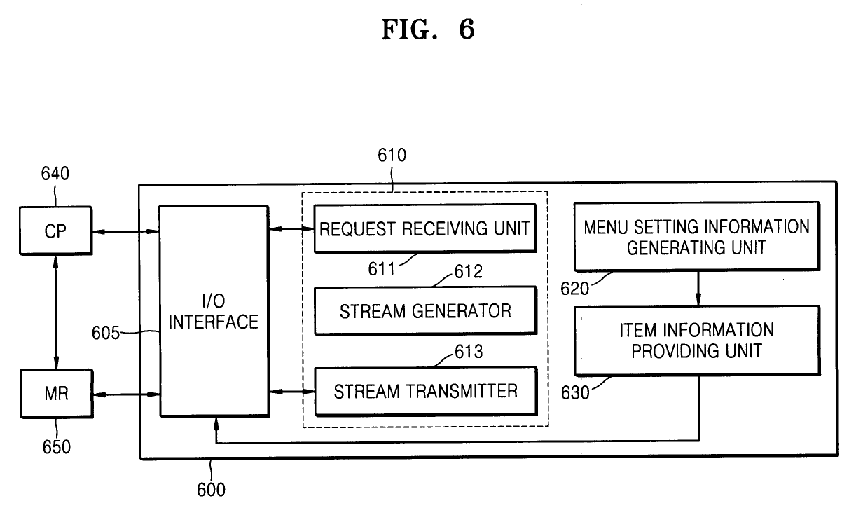

FIG. 6 is a block diagram of a media server 600 according to an exemplary embodiment of the present invention. Referring to FIG. 6, the media server 600 includes an input/output (I/O) interface 605, a content transmission unit 610, an item information providing unit 630, and a menu setting information generating unit 620. The I/O interface 605 provides a means via which the media server 600 establishes communications with the control point 640 and the media renderer 650, and the menu setting information generation unit 620 extracts menu information from a DVD in order to generate menu setting information.

The item information providing unit 630 receives the menu setting information from the menu setting information generating unit 620, generates item information for each piece of the menu setting information, and transmits the item information to the control point 640 in response to a a CDS Browse call message from the control point 640.

The content transmission unit 610 includes a request receiving unit 611, a stream generator 612, and a stream transmitter 613. The request receiving unit 611 receives a Play call message from the media renderer 650, and transmits it to the stream generator 612 in response to a request from the control point 640. The stream generator 612 generates stream data of DVD content based on the menu setting information contained in the Play call message. The stream transmitter 613 transmits the generated stream data to the media renderer 650 via the I/O interface 605.

The above exemplary embodiments of the present invention can be embodied as a computer program in a computer readable medium, and executed by a general digital computer via a computer readable medium. The computer readable medium may be a magnetic storage medium, e.g., a read-only memory (ROM), a floppy disk, and a hard disc, an optical storage medium, e.g., a compact disc (CD)-ROM, and a DVD, and a carrier wave that transmits data via the Internet, for example.

According to the exemplary embodiments of the present invention, by newly defining content information in a CDS of a media server without altering the existing UPnP control point, a user can use various menu information items related to a DVD title, which is the same as can be obtained in a local DVD system, while evaluating DVD content using a remote control via a network.

What is claimed is:

1. A method of allowing a media server to provide digital versatile disc (DVD) content in a universal plug and play (UPnP) network, the method comprising:
(a) generating at least two types of menu setting information based on combinations of options available from a menu for the DVD content;
(b) generating item information for the DVD content for each piece of the menu setting information, and transmitting the generated item information to a control point; and
(c) transmitting the DVD content to a media renderer designated by the control point, to which menu setting information corresponding to the item information is applied.

2. The method of claim 1, wherein (b) comprises transmitting the item information in response to a content directory service (CDS) browse call message from the control point.

3. The method of claim 2, wherein each piece of the menu setting information is inserted into a tag representing a title of the DVD content in the item information.

4. The method of claim 1, wherein (c) comprises:
(c1) receiving a request for content corresponding to a portion of the
While this invention has been particularly shown and described with reference to exemplary embodiments thereof, it will be understood by those skilled in the art that various changes in form and details may be made therein without departing from the spirit and scope of the invention as defined by the appended claims.
generated item information from the media renderer;
(c2) generating stream data of the DVD content based on the menu setting information corresponding to the portion of the generated item information corresponding to the request for content; and
(c3) transmitting the stream data to the media renderer.

5. The method of claim 1, wherein the menu setting information comprises information for selection of at least one of a language, an audio mode, and a subtitle.

6. A computer readable medium having recorded thereon a computer program for the method of claim 1.

7. A media server apparatus for providing digital versatile disc (DVD) content in a universal plug and play (UPnP) network, comprising:
a menu setting information generating unit which generates two or more types of menu setting information from combinations of options available from a menu for the DVD content;
an item information providing unit which generates item information for the DVD content for each piece of the generated menu setting information, and transmits the generated item information to a control point; and
a content transmission unit which transmits the DVD content to a media renderer designated by the control point, to which menu setting information corresponding to a the item information requested by the control point is applied.

8. The media server apparatus of claim 7, wherein the item information providing unit transmits the item information in response to a content directory service (CDS) browse call message from the control point.

9. The media server apparatus of claim 8, wherein the item information providing unit inserts each piece of the menu setting information into a tag representing a title of the DVD content in the item information.

10. The media server apparatus of claim 7, wherein the content transmission unit comprises:
a request receiving unit which receives a request for content corresponding to a piece of the generated item information from the media renderer;
a stream generator which generates stream data of the DVD content based on the piece of the generated item information; and
a stream transmitter transmitting the stream data to the media renderer.

11. The media server apparatus of claim 7, wherein the menu setting information comprises information for selection of at least one of a language, an audio mode, and a subtitle.

12. A method of a media server providing digital versatile disc (DVD) content in a universal plug and play (UPnP) network, the method comprising:
extracting DVD menu options from a DVD;
generating item information representing selectable combinations of the extracted DVD menu options; and
transmitting the item information to a control point.

13. The method of claim 12, further comprising:
receiving a request from a control point representing one of the selectable combinations of the extracted DVD menu options;
transmitting the DVD content to a media renderer based on the received request.
